(19) United States
(12) Patent Application Publication
(10) Pub. No.: US 2020/0054106 A1
(43) Pub. Date: Feb. 20, 2020

(54) KEY CASE

(71) Applicants: Anna TANAKA, Tochigi (JP); SHINWA CORPORATION, Gunma (JP)

(72) Inventors: Hiroshi ARAI, Gunma (JP); Junichi TANAKA, Gunma (JP)

(73) Assignees: SHINWA CORPORATION, Gunma (JP); Anna Tanaka, Tochigi (JP)

(21) Appl. No.: 16/522,053

(22) Filed: Jul. 25, 2019

(30) Foreign Application Priority Data
Jul. 26, 2018 (JP) 2018-140224

(51) Int. Cl. A45C 11/32; G07C 9/00

(52) U.S. Cl. CPC A45C 11/32; B60R 25/24; G07C 9/00571

(57) ABSTRACT

A key case includes an outer case having an opening portion at one end of the outer case and an inner case accommodating an electronic key and placed inside the outer case. The outer case and the inner case of the key case are plated with metal or composed of metal.

The present invention enjoys the benefit of priority claim based on the patent application of Japanese Patent Application No. 2018-140224 filed on Jul. 26, 2018 in Japan, and the contents described in the patent application are all incorporated herein by reference.

### TECHNICAL FIELD

The present invention relates to a key case, in particular, to a key case having a relay attack protection function.

### BACKGROUND ART

An authentication system for a vehicle is known that locks or unlocks a door and starts the engine in response to the user of an electronic key touching a touch sensor provided on a door handle and pressing an engine start button.

Unfortunately, such an authentication system for a vehicle is vulnerable to a vehicle theft technique known as relay attack. Relay attack is a technique of establishing authentication between an in-vehicle device and an electronic key via a repeater, regardless of the distance between the in-vehicle device and the electronic key.

A technique for providing protection against such relay attack is described in, for example, Patent Document 1. Patent Document 1 describes an authentication system for a vehicle including a means for suspending the authentication function in response to a trigger intentionally transmitted by the user.
Patent Document 1: Japanese Unexamined Patent Application Publication No. 2016-79600

### SUMMARY

The technique according to Patent Document 1 requires the in-vehicle device to support the means for suspending the authentication function in order to protect the vehicle from a relay attack. Thus, if the in-vehicle device does not support the means for suspending the authentication function, the vehicle unfortunately cannot be protected against a relay attack.

Thus, it is difficult to protect a vehicle from a relay attack without an in-vehicle device supporting the suspension of the authentication function.

An object of the present invention is to provide a key case that can solve difficulty in protecting a vehicle from a relay attack without an in-vehicle device supporting suspension of an authentication function.

A key case according to an exemplary embodiment of the present invention for achieving the above-described object includes an outer case having an opening portion at one end of the outer case; and an inner case accommodating an electronic key and placed inside the outer case, the outer case and the inner case being plated with metal or composed of metal.

In the key case, the inner case slides inside the outer case to be accommodated in the outer case and includes a protrusion latchable to at least one recess in the inner side face of the outer case, and the protrusion latches to the at least one recess to hold the inner case and the outer case in a predetermined state.

In the key case, the at least one recess of the outer case includes a first recess and a second recess, the first recess latching to the protrusion of the inner case while the inner case is placed inside the outer case, the second recess latching to the protrusion while at least a portion of the electronic key placed inside the inner case is exposed to the outside of the outer case.

In the key case, the inner case including a shell covering at least a portion of the electronic key placed inside the inner case.

In the key case, the shell is disposed on the inner case at a position adjacent to the opening portion of the outer case with the inner case placed inside the outer case and covers at least an antenna portion of the electronic key placed inside the inner case.

Exemplary embodiments of the present invention provide a key case that can solve difficulty of protecting a vehicle from a relay attack without an in-vehicle device supporting suspension of an authentication function.

### BRIEF DESCRIPTION OF DRAWINGS

FIG. 1 is a perspective view of an example overall configuration of a key case according to a first exemplary embodiment of the present invention.

FIG. 2 is a perspective view of the key case including an inner case partially pulled out.

FIG. 3 is a perspective view of an example configuration of the inner case.

FIG. 4 is a perspective view of the inner case accommodating an electronic key.

FIG. 5 is a cross-sectional view of an example configuration of the key case.

FIG. 6 is a cross-sectional view of an example configuration of the key case with the inner case partially pulled out.

FIG. 7 is a perspective view of another example configuration of the inner case.

### EXEMPLARY EMBODIMENT

### First Exemplary Embodiment

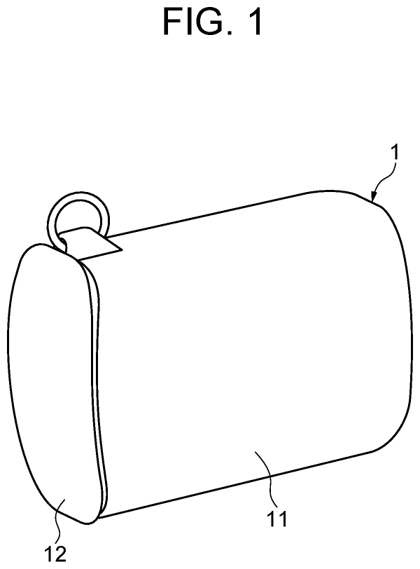

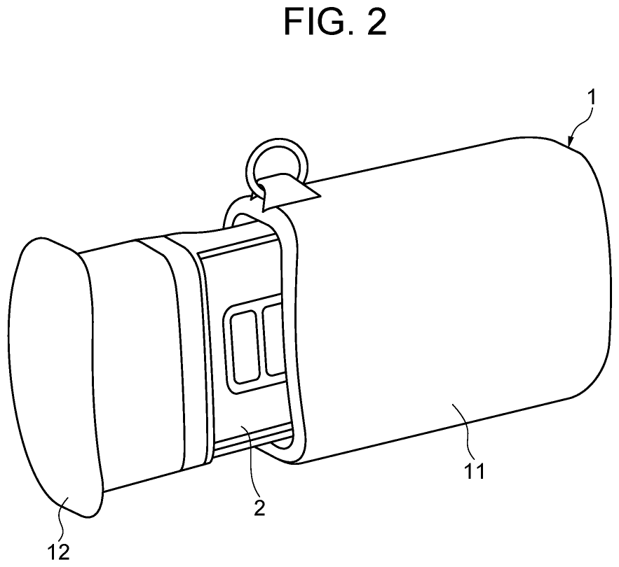

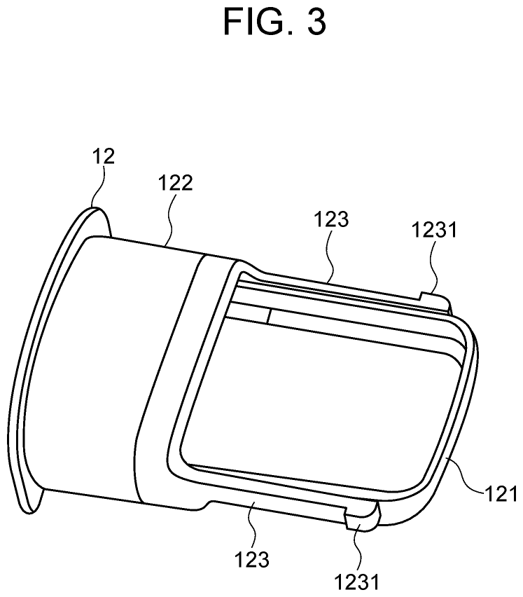

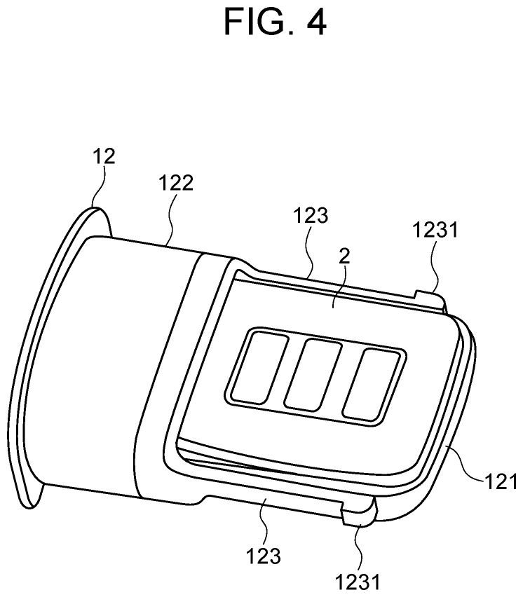

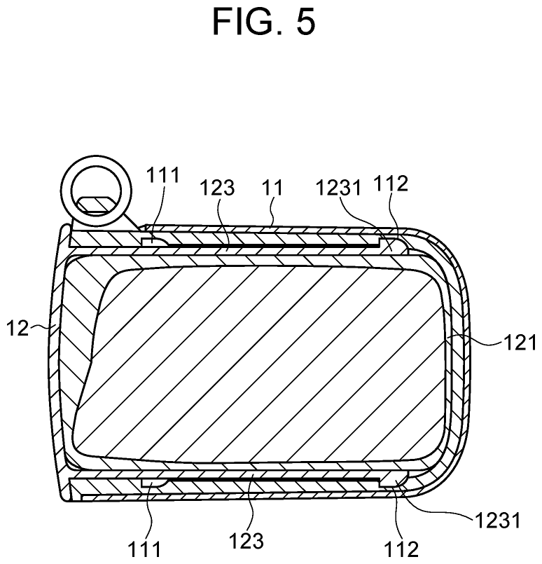

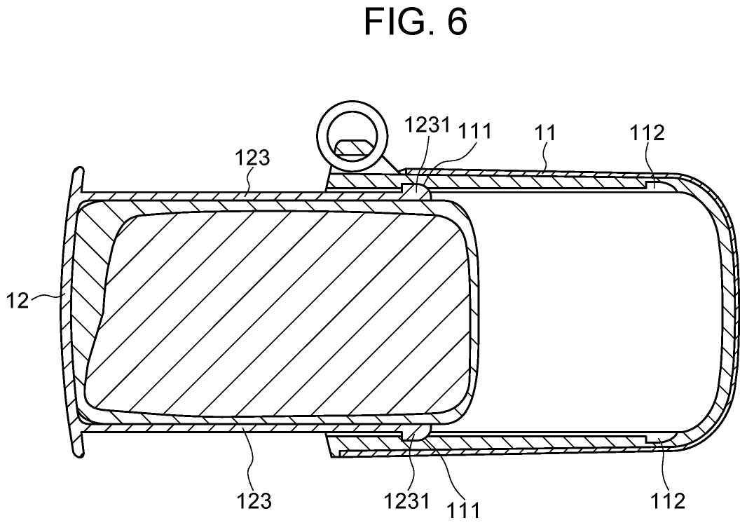

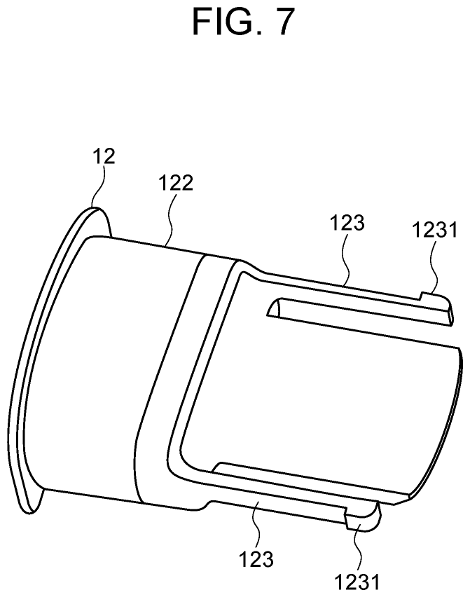

A first exemplary embodiment of the present invention will now be described with reference to FIGS. 1 to 7. FIG. 1 is a perspective view of an example overall configuration of a key case 1. FIG. 2 is a perspective view of the key case 1 including an inner case 12 partially pulled out. FIG. 3 is a perspective view of an example configuration of the inner case 12. FIG. 4 is a perspective view of the inner case 12 accommodating an electronic key 2. FIG. 5 is a cross-sectional view of an example configuration of the key case 1. FIG. 6 is a cross-sectional view of the key case 1 with the inner case 12 partially pulled out. FIG. 7 is a perspective view of another example configuration of the inner case 12.

The key case 1 is a box-shaped case accommodating the electronic key 2. FIG. 1 illustrates an exemplary box-shaped case having rounded corners. The key case 1 is, for example, a plastic casing plated with metal, such as aluminum, copper, or steel. Alternatively, the key case 1 may be composed of metal, such as copper or iron.

The plastic casing can be plated through a known plating technique. For example, plastic can be plated through the processes of, for example, degreasing, etching, catalyzing, electroless or direct electroplating, or electrolytic plating. The key case 1 may have a typical layered structure of plating, such as a three-layer structure of copper, nickel, and chromium. For example, the key case 1 according to this exemplary embodiment is plated with a copper layer having at least a thickness of approximately 3 micrometers. The key case 1 may be plated through any process besides those mentioned above, and may have any other layered structure besides that mentioned above.

FIG. 1 is a perspective view of an example overall configuration of the key case 1. FIG. 2 is a perspective view of the key case 1 including an inner case 12 partially pulled out. With reference to FIGS. 1 and 2, the key case 1 includes an outer case 11 and an inner case 12.

As illustrated in FIGS. 1 and 2, the inner case 12, for example, is slidable along grooves formed on the inner faces of the outer case 11. In other words, the inner case 12 can slide relative to the outer case 11 and be placed inside the outer case 11. Sliding the inner case 12 causes the positional relation between the inner case 12 and the outer case 11 to change, for example, among a state in which the electronic key 2 placed inside the inner case 12 is not exposed to the outside of the outer case 11 (the state illustrated in FIG. 1), a state in which the electronic key 2 placed inside the inner case 12 is exposed to the outside of the outer case 11 (the state illustrate din FIG. 2), and a state in which the inner case 12 is separated from the outer case 11 (the state illustrated in FIGS. 3 and 4).

For example, for the state illustrated in FIG. 1, the inner case 12 is placed inside the outer case 11 while the head portion of the inner case 12 is exposed to the outside of the outer case 11. In this state, the head portion of the inner case 12 fits to the outer case 11 to tightly close the key case 1 and block signals generated by the electronic key 2 placed inside the inner case 12. In the state illustrated in FIG. 2, the electronic key 2 placed inside inner case 12 is exposed to the outside of the outer case 11. In this state, the signals generated by the electronic key 2 are not blocked by the key case 1.

As described below, the key case 1 according to this exemplary embodiment can hold the positional relation between the inner case 12 and the outer case 11 in, for example, a state in which the electronic key 2 placed inside the inner case 12 is not exposed to the outside of the outer case 11 (the state illustrated in FIG. 1) or a state in which the electronic key 2 placed inside in the inner case 12 is exposed to the outside of the outer case 11 (the state illustrated in FIG. 2). That is, according to this exemplary embodiment, the inner case 12 can be pulled out from the outer case 11 by a predetermined length and held at that position. Details of this feature will be described below.

The inner case 12 can accommodate the electronic key 2 and be placed inside the outer case 11 while accommodating the electronic key 2. The inner case 12 is, for example, a plastic casing plated with metal, such as aluminum, copper, or steel. Alternatively, at least a portion of the inner case 12 may be composed of metal.

FIG. 3 illustrates an example configuration of the inner case 12 without the electronic key 2 placed inside the inner case 12. FIG. 4 illustrates an example configuration of the inner case 12 with the electronic key 2 placed inside the inner case 12. With reference to FIGS. 3 and 4, the inner case 12 includes a container 121, a shell 122, and latches 123.

The container 121 has a depression having a shape corresponding to the external shape of the electronic key 2 and accommodating the electronic key 2. The depression is formed in a protective member disposed inside the container 121 and composed of a material such as urethane foam or polyethylene foam. The depression in the protective member disposed inside the container 121 protects and holds the electronic key 2 placed inside the container 121.

The shell 122 is disposed on the inner case 12 at a position adjacent to the opening portion of the outer case 11 when the inner case 12 is placed inside the outer case 11. The shell 122 covers at least a portion of the electronic key 2 when the electronic key 2 is placed inside the container 121. When the electronic key 2 is placed inside the container 121, at least a portion of the electronic key 2 is surrounded by the shell 122 of the inner case 12, which is plated with metal. For example, the shell 122 covers approximately ½ to ⅓ of the surface of the electronic key 2 placed inside the container 121. In this way, when the inner case 12 is placed inside the outer case 11, the signals generated by the electronic key 2 can be certainly blocked.

For effective signal blocking by the shell 122, it is desirable to place the electronic key 2 in the container 121 such that the antenna portion of the electronic key 2 that outputs signals is placed inside the shell 122. In other words, it is desirable that the shell 122 is disposed at a position that covers at least the antenna portion of the electronic key 2 held inside the container 121. To achieve such placement of the electronic key 2, the depression formed in the protective member may have a shape matching the external shape of the electronic key 2 placed inside the shell 122 such that the antenna portion is covered by the shell 122.

The latches 123 are rod-like members having protrusions 1231 disposed at the tips of the latches 123. The latches 123 are, for example, resilient and can move in the medial direction by pushing the latches 123 with fingers of the user.

The protrusions 1231 disposed at the tips of the latches 123 have shapes matching recesses 111 and 112 formed in the outer case 11, as described below. The protrusions 1231 of the latches 123 are latched to the recesses 111 and 112 to hold the positional relation of the inner case 12 and the outer case 11 in a predetermined state.

FIG. 5 is a cross-sectional view of the key case 1 with the inner case 12 placed inside the outer case 11. FIG. 6 is a cross-sectional view of the key case 1 with the inner case 12 partially pulled out. With reference to FIG. 5, the protrusions 1231 can latch to the recesses 112 to hold the inner case 12 on the outer case 11 such that the electronic key 2 placed inside the inner case 12 is not exposed to the outside of the outer case 11 as illustrated in FIG. 1 (a state in which the inner case 12 is not pulled out). With reference to FIG. 6, the protrusions 1231 can latch to the recesses 111 to hold the inner case 12 on the outer case 11 such that the electronic key 2 placed inside the inner case 12 is exposed to the outside of the outer case 11 as illustrated in FIG. 2 (a state in which the inner case 12 is pulled out).

An example configuration of the inner case 12 has been described above.

The outer case 11 has an opening portion at one end (opening end) and accommodates the inner case 12 while a portion (head portion) of the inner case 12 is exposed to the outside of the outer case 11. The outer case 11 is, for example, a plastic casing plated with metal, such as aluminum, copper, or steel. Alternatively, at least a portion of the outer case 11 may be composed of metal.

The outer case 11 has grooves in the central regions of the inner side faces (for example, at positions corresponding to the latches 123 of the inner case 12). The recesses 111 and 112 are formed at predetermined positions in the grooves.

As described above, the recesses 111 112 have shapes corresponding to the shapes of the protrusions 1231 of the latches 123. The protrusions 1231 are latched to the recesses 111 or 112 to hold the outer case 11 and the inner case 12 in a predetermined positional relation.

FIGS. 5 and 6 illustrate two sets of recesses 111 and 112 formed in the outer case 11. Alternatively, any number of sets of recesses besides two may be formed in the outer case 11. For example, the outer case 11 may have one set of recesses or three or more sets of recesses.

An example configuration of the key case 1 has been described above.

The protective member (container 121) having the depression may be detachable from the inner case 12. FIG. 7 illustrates an example configuration of the inner case 12 without a protective member. The inner case 12 may not include a protective member having a depression, as illustrated in FIG. 7. With reference to FIG. 7, it is desirable that a plated plate be disposed over the exterior of the protective member.

In this way, the key case 1 includes the outer case 11 and the inner case 12 plated or composed of metal. Through such a configuration, the inner case 12 accommodating the electronic key 2 can be placed inside the outer case 11, to block signals generated by the electronic key 2. As a result, the vehicle can be protected from a relay attack without an in-vehicle device supporting suspension of an authentication function. The key case 1 can readily enter a mode in which the signals generated by the electronic key 2 are not blocked, by pulling out the inner case 12, as illustrated in FIG. 2. In this way, the authentication system can readily enter a mode in which the vehicle is protected from a relay attack while the vehicle doors can be locked/unlocked and the engine can be started in response to the user of the electronic key touching the touch sensor on the door handle or pressing an engine start button.

In the key case 1 according to this exemplary embodiment, the protrusions 1231 and the recesses 111 and 112 hold the positional relation of the outer case 11 and the inner case 12 in a predetermined state. This can enhance convenience.

In the key case 1 according to this exemplary embodiment, the inner case 12 is provided with the shell 122. Through such a configuration, the electronic key 2 can be placed in the container 121 such that the antenna portion of the electronic key 2 outputting signals is positioned inside the shell 122, to completely block the signals generated by the electronic key 2. As a result, the vehicle can be certainly protected from a relay attack.

Although the present invention has been described on the basis of the exemplary embodiments, the present invention is not limited to the exemplary embodiments described above. Alternatively, for example, the external shape of the key case 1 may be modified such that the corners are not rounded. Alternatively, the inner case 12 and the outer case 11 may be held in a predetermined state with any means besides the protrusions 1231 and the recesses 111 and 112. Various modifications understandable by one skilled in the art may be made to the configurations and details of the present invention within the scope of the invention.

### REFERENCE NUMERALS

1 key case
11 outer case
111 recess
112 recess
12 inner case
121 container
122 shell
123 latch
1231 protrusion
2 electronic key

1. A key case comprising:
an outer case having an opening portion at one end of the outer case; and
an inner case accommodating an electronic key and placed inside the outer case,
the outer case and the inner case being plated with metal or comprise metal.

2. The key case according to claim 1, wherein,
the inner case slides inside the outer case to be accommodated in the outer case and comprises a protrusion latchable to at least one recess in the inner side face of the outer case, and
the protrusion latches to the at least one recess to hold the inner case and the outer case in a predetermined state.

3. The key case according to claim 2, wherein the at least one recess of the outer case comprises a first recess and a second recess, the first recess latching to the protrusion of the inner case while the inner case is placed inside the outer case, the second recess latching to the protrusion while at least a portion of the electronic key placed inside the inner case is exposed to the outside of the outer case.

4. The key case according to claim 1, wherein the inner case comprises a shell covering at least a portion of the electronic key placed inside the inner case.

5. The key case according to claim 4, wherein the shell is disposed on the inner case at a position adjacent to the opening portion of the outer case with the inner case placed inside the outer case and covers at least an antenna portion of the electronic key placed inside the inner case.
